(19) United States
(12) Patent Application Publication
(10) Pub. No.: US 2021/0358016 A1
(43) Pub. Date: Nov. 18, 2021

(54) A kind of E-commerce trading system platform consist of the manufacturer's M shop, the dealer's D shop and the consumer using functions

(71) Applicant: SHANGHAI VALCA INDUSTRY CO., LTD, Shanghai (CN)

(72) Inventor: Dongkai Li, Shanghai (CN)

(21) Appl. No.: 16/969,555

(22) PCT Filed: Dec. 3, 2018
(86) PCT No.: PCT/CN2018/118919

§ 371 Date: Sep. 30, 2020

(30) Foreign Application Priority Data
Feb. 12, 2018 (CN) 201810143649.7

(51) Int. Cl. G06Q 30/06

(52) U.S. Cl. CPC G06Q 30/0635; G06Q 30/0611; G06Q 30/0605

(57) ABSTRACT

A manufacturer (M), dealer (D) and consumer (C) joint transaction system and a transaction method are provided. The system includes: a manufacturer (M) client, a dealer (D) client, a consumer (C) client, and a cloud data server, wherein the cloud data server provides a manufacturer (M) operating space to the manufacturer (M) client, a dealer (D) operating space to the dealer (D) client, and a consumer (C) operating space to the consumer (C) client. The present invention effectively combines e-commerce and real industry and commerce marketing channel systems, thereby solving serious conflict between a popular B2C or B2B e-commerce model and an actual business ecosystem, which allows real manufacturers (M), dealers (D), and consumers (C) to realize e-commerce operations easily.

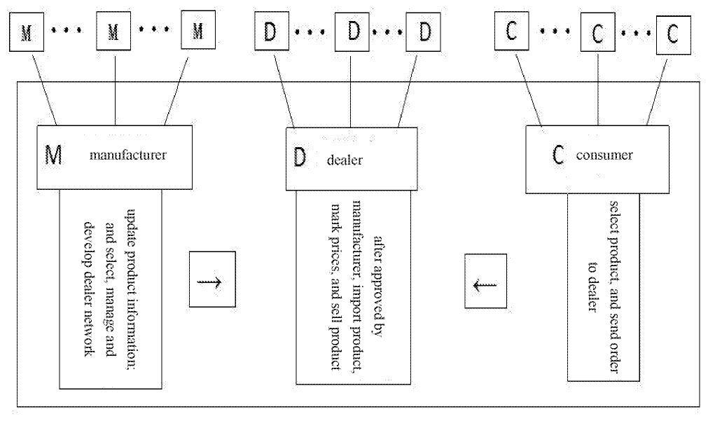

### BACKGROUND OF THE PRESENT INVENTION

### Field of Invention

The present invention relates to an e-commerce platform system, and more particularly to a manufacturer, dealer and consumer joint transaction system and transaction method.

### Description of Related Arts

1. Conventional management software for enterprise is used independently, which has no relevance unity of business interactions that are completely open and compatible to the outside world.

2. Under the conventional architecture model of the Internet business transaction platform, the stationed dealer edits, displays, prices, and sells independently, leading to two problems. First, the brand owner or manufacturer needs to avoid conflict with its actual channel dealer system, and cannot enter such platforms for sales business. As a result, Internet commercial use of the brand owner or manufacturer so far only stays at displaying the basic information of the enterprise. Second, if online sales of the dealer have no regional restriction, it will inevitably conflict with its authorized distribution area. Therefore, it is also impossible to effectively use the commerce Internet platform to develop business, can only stay at displaying the basic information of the company.

3. Effective application of the transaction forms generated by the conventional Internet transaction platform structure is mainly for certain standardized personal consumer products, and cannot be adapted to the various products front various industries.

4. Since it is widely believed that e-commerce is to eliminate middlemen, traditional business entity practitioners are averse to the popular B2C e-commerce model.

Due to the above problems, it is impossible for almost all manufacturers or brand owners with traditional channel systems to perform online marketing effectively and comprehensively, and e-commerce and real business cannot be effectively combined. Multi-variety and multi-batch professional sales and procurements are difficult to carry out through the Internet transaction platform, which are still mainly traded in various offline material product markets.

### to SUMMARY OF THE PRESENT INVENTION

An object of the present invention is to provide a manufacturer, dealer and consumer joint transaction system and operation method based on integrated business invitation and sales of factory manufacturers, supply and sale of dealers, and purchase of consumers, which can also be abbreviated as MDC joint transaction system and operation method. M stands for manufacturer (Manufacturer, abbreviation M), D stands for dealer (Dealer, abbreviation D), and C stands for consumer (Consumer, abbreviation C).

Accordingly, in order to accomplish the above objects, the present invention provides:

a system for manufacturer, dealer and consumer joint transaction, comprising: a manufacturer's side, a dealer's side, a consumer end, and a cloud data server, wherein the cloud data server provides a manufacturer operating space to the manufacturer's side, a dealer operating space to the dealer's side, and a consumer operating space to the consumer end; wherein 1) the manufacturer's side

the manufacturer's side enables a manufacturer to register identity information in the manufacturer operating space provided by the cloud data server of the system, to publish and update product introductions, to select dealers from various places to settle on a platform, and to designate a distribution area; the manufacture receives an order sent by the dealer's side and generates a production plan based on a manufacture product inventory until shipment is completed;

2) the dealer's side

the dealer's side enable a dealer to register identity information in the dealer operating space provided by the cloud data server of the system, to submit a dealer to application to the manufacturer, and to conduct online and offline operations in the distribution area designated by the manufacturer after the dealer application is approved; the dealer imports product information from the manufacturer operating space through the cloud data server of the system, and then fills in a dealer product inventory, prices and transaction terms, so as to publish and sell products online; the dealer receives a purchase inquiry or an order from a consumer through the cloud data server of the system which enables the dealer and the consumer to communicate online and trade offline; after trading, the dealer product inventory changes accordingly, and the dealer sends a purchase order to the manufacturer according to the dealer product inventory;

3) the consumer end

the consumer end enables the consumer to register identity information in the consumer operating space provided by the cloud data server of the system, to perform dealer search within a certain area nearby through the cloud data server of the system, to select a desired product, and to send the purchase inquiry to the dealer or directly settle purchase online; and

4) the cloud data server

the cloud data server is used to set operation authorities and scopes of the manufacturer, the dealer and the consumer, and to schedule and manage a transaction process

The present invention also provides a method for manufacturer, dealer and consumer joint transaction with the above system, comprising steps of:

step 1. publishing and updating product and manufacturer information to the manufacturer operating space of the cloud data server by a registered manufacture through the manufacturer's side;

step 2, selecting registered dealers from various places by the manufacturer on the system, or allowing approved a dealer to settle on the platform, thereby confirming a cooperation relationship between the manufacture and the dealer, as well as a sale scope; wherein the sale scope comprises products to be sold, sale areas and quantifies; and then performing data association between the manufacture and the dealer;

step 3, forbidding the dealer to edit and upload product pictures to a store, but allowing the dealer to import product information authorized by the manufacturer after being approved by the manufacturer; filling in the dealer product inventory, the prices and the transaction terms by the dealer, so as to publish and sell the products online in the store, wherein products no longer available for sale are removed, and dealer product data are automatically updated when manufacturer product data are updated;

step 4, searching for the desired product by the consumer within a certain area nearby through the cloud data server of the system, and sending the purchase inquiry to the dealer or directly settling the purchase online;

step 5, after receiving the purchase inquiry, negotiating between the consumer and the dealer online until the order is confirmed or cancelled;

step 6, after receiving a confirmed order from the consumer, issuing a shipment order and shipping the product by the dealer to the consumer if the dealer product inventory is sufficient, or generating and sending the purchase order to the manufacturer if the dealer product inventory is insufficient;

step 7, after confirming the purchase order sent by the dealer, comparing product inventory data; when the manufacture product inventory is insufficient or reaches an inventory warning line, generating and sending the production plan to a production department, and then executing a step 8; when the manufacture product inventory is sufficient, confirming the purchase order by a sales department of the to manufacturer, and issuing a shipment order and shipping the product to the dealer, and then executing a step 9;

step 8, after the production department completes order production, importing new product data information into a product database, wherein the system automatically sends product warehousing and saleable information to the sales department;

step 9, after the sales department of the manufacturer issues the shipment order and ships the product to the dealer, automatically updating original product information in the product database;

step 10, after the dealer receives and confirms the shipping order from the manufacturer, automatically updating the new product data information to the dealer product inventory; and

step 11, sending shipping order information to the consumer by the dealer, and updating the dealer product inventory accordingly.

Beneficial Effects of the Present Invention:

1. There will be no online and offline conflicts in regional marketing of the manufacturer brand owner). The dealer can only conduct online and offline marketing within the designated geographic area. The manufacturer can fully and effectively manage, review, supervise and develop the dealer through the system.

2. The dealer cannot edit or upload the product information to the store, but can only import the product information edited by the manufacturer for online display and sales, so that a source of fake products is eliminated, and rights and interests of the brand owner and the consumer are better maintained.

3. A competent dealer can simultaneously carry out business in more geographical areas with the system, which improves and expands business for the dealer (intermediary).

4. Engineering professional consumers can easily finish highly professional procurements with the system, thereby reducing labor and cost in traditional offline market.

5. Purchased product and quantity information of the consumer can be automatically transmitted to the dealer product inventory to change it in time, and then transmitted to a sale and production plan database of the manufacturer (brand owner) in time, thereby associating three-party supply and sale data. All parties can share a supply and sale business data management software system, which greatly reduces software application management cost.

6. After the manufacturer, the dealer, and the consumer are unified into the system, the system can effectively collect and accumulate big data of three-party industrial and commercial operations. Therefore, more effective new business and new services can be generated.

### BRIEF DESCRIPTION OF THE DRAWINGS

FIGURE is a flow chart of an MDC transaction of the present invention.

### DETAILED DESCRIPTION OF THE PREFERRED EMBODIMENT

Core of the present invention: an MDC unified e-commerce operation architecture is created through software programming and cloud data information technology. A core feature is that a manufacturer can edit and upload product information; a dealer cannot edit and upload the product information to a store, but can only import products or services to be sold from manufacturer product data after being approved by the manufacturer; then prices and other transaction terms can be marked for a consumer to purchase; and the consumer can only search dealer within a certain area nearby to conduct online communications and transactions.

Hardware Framework

A manufacturer's side, a dealer's side, a consumer end, and a cloud data server.

Referring to FIGURE, a manufacturer, dealer and consumer joint relationship is illustrated.

is a system for manufacturer, dealer and consumer joint transaction comprises: a manufacturer's side, a dealer's side, a consumer end, and a cloud data server, wherein the cloud data server provides a manufacturer operating space to the manufacturer's side, a dealer operating space to the dealer's side, and a consumer operating space to the consumer end; wherein

1) The Manufacturer's Side

the manufacturer's side enables a manufacturer to register identity information in the manufacturer operating space provided by the cloud data server of the system, to publish and update product introductions, to select dealers from various places to settle on a platform, and to designate a distribution area; the manufacture receives an order sent by the dealer's side and generates a production plan based on a manufacture product inventory until shipment is completed;

2) The Dealer's Side

the dealer's side enable a dealer to register identity information in the dealer operating space provided by the cloud data server of the system, to submit a dealer application to the manufacturer, and to conduct online and offline operations in the distribution area designated by the manufacturer after the dealer application is approved; the dealer imports product information from the manufacturer operating space through the cloud data server of the system, and then fills in a dealer product inventory, prices and transaction terms, so as to publish and sell products online; the dealer receives a purchase inquiry or an order from a consumer through the cloud data server of the system which enables the dealer and the consumer to communicate to online and trade offline; after trading, the dealer product inventory changes accordingly, and the dealer sends a purchase order to the manufacturer according to the dealer product inventory;

3) The Consumer End

the consumer end enables the consumer to register identity information in the consumer operating space provided by the cloud data server of the system, to perform dealer search within a certain area nearby through the cloud data server of the system, to select a desired product, and to send the purchase inquiry to the dealer or directly settle purchase online; and

4) The Cloud Data Server

the cloud data server is used to set operation authorities and scopes of the manufacturer, the dealer and the consumer, and to schedule and manage a transaction process

### Embodiment 1

A method of the present invention comprises steps of:

step 1, publishing and updating product and manufacturer information to the manufacturer operating space of the cloud data server by a registered manufacture through the manufacturer's side;

step 2, selecting registered dealers from various places by the manufacturer on the system, or allowing approved a dealer to settle on the platform, thereby confirming a cooperation relationship between the manufacture and the dealer, as well as a sale scope; wherein the sale scope comprises products to be sold, sale areas and quantities; and then performing data association between the manufacture and the dealer;

step 3, forbidding the dealer to edit and upload product pictures to a store, but allowing the dealer to import product information authorized by the manufacturer after being approved by the manufacturer; filling in the dealer product inventory, the to prices and the transaction terms by the dealer, so as to publish and sell the products online in the store, wherein products no longer available for sale are removed, and dealer product data are automatically updated when manufacturer product data are updated;

step 4, searching for the desired product by the consumer within a certain area nearby through the cloud data server of the system, and sending the purchase inquiry to the dealer or directly settling the purchase online;

step 5, after receiving the purchase inquiry, negotiating between the consumer and the dealer online until the order is confirmed or cancelled;

step 6, after receiving a confirmed order from the consumer, issuing a shipment order and shipping the product by the dealer to the consumer if the dealer product inventory is sufficient, or generating and sending the purchase order to the manufacturer if the dealer product inventory is insufficient;

step 7, after confirming the purchase order sent by the dealer, comparing product inventory data; when the manufacture product inventory is insufficient or reaches an inventory warning line, generating and sending the production plan to a production department, and then executing a step 8; when the manufacture product inventory is sufficient, confirming the purchase order by a sales department of the manufacturer and issuing a shipment order and shipping the product to the dealer and then executing a step 9;

step 8, after the production department completes order production, importing new product data. information into a product database, wherein the system automatically sends product warehousing and saleable information to the sales department;

step 9, after the sales department of the manufacturer issues the shipment order and ships the product to the dealer, automatically updating original product information in the product database;

step 10, after the dealer receives and confirms the shipping order from the manufacturer, automatically updating the new product data information to the dealer product inventory; and

step 11, sending shipping order information to the consumer by the dealer, and updating the dealer product inventory accordingly.

The product introduction comprises one or more of texts, pictures, short videos and multimedia plug-ins. After the manufacturer approves the dealer to import the product data, the dealer has no right to edit the product pictures, texts or short videos, but can only mark the transaction terms such as product prices and quantities, and then put on shelf for sale, so as to prevent the dealer from selling unreal products. Therefore, product brand effects and legitimate rights and interests of the manufacturer and the consumer are maintained.

The purchase order from the consumer is fed back to the dealer operating space through the cloud data server, and the dealer resends the purchase order to the manufacturer operating space through the cloud data server. The manufacturer arranges the production department to replenish or arranges the sales department to directly shipping according to the purchase order. Then the inventory data are fed back to the dealer operating space in real time through the cloud data server.

The product data in the store of the dealer is automatically updated when manufacturer database is updated.

The transaction system controls the manufacturer, the dealer, and the consumer through the cloud data server of the joint transaction system, and updates the consumer purchase order, the dealer inventory data of and manufacturer inventory data in real time, which facilitates the consumer to find the dealer and send the purchase order, facilitates the dealer to send the order to the manufacturer, facilitates the manufacturer to arrange production and shipment according to inventory, and facilitates other production, marketing, and procurement operations. The system saves time and reduces transaction-related costs.

In summary, the above are only preferred embodiments of the present to invention, and are not intended to limit the implementation scope of the present invention. All equivalent changes and modifications made in accordance with the scope of the present invention should be covered by the technical scope of the present invention.

1-3. (canceled)

4. A system for manufacturer, dealer and consumer joint transaction comprising:
a manufacturer's side, a dealer's side, a consumer end, and a cloud data server, wherein the cloud data server provides a manufacturer operating space to the manufacturer's side, a dealer operating space to the dealer's side, and a consumer operating space to the consumer end; the cloud date server is also used to set operation authorities and scopes of a manufacturer, a dealer and a consumer; wherein the manufacturer's side enables the manufacturer to select dealers from various places to settle on a platform, and to designate a sale scope; the dealer's side enable the dealer to submit a dealer application to the manufacturer, and to conduct online and/or offline operations within the sale scope designated by the manufacturer after the dealer application is approved; the consumer end enables the consumer to perform dealer search within a certain area nearby through the cloud data server, and to settle purchase with the dealer.

5. The system, as recited in claim 4, wherein the sale scope comprises products to be sold, sale areas and quantities; and data association is performed between the manufacture, the dealer and the customer within the sale scope.

6. The system, as recited in claim 5, wherein the manufacturer's side edits and uploads product or service information but not sell online; the dealer's side does not edit and upload the product or service information, but only imports the product or service information from a product database of the manufacturer or a superior dealer to whom a cooperative relationship is established; dealer product data are automatically updated when manufacturer product data are updated.

7. The system, as recited in claim 5, wherein the consumer end enables the consumer to select a desired product online, and to send a purchase inquiry to the dealer or directly settle the purchase online.

8. The system, as recited in claim 7, wherein the dealer's end receives the purchase inquiry or an order from the consumer through the cloud data server of the system, which enables the dealer and the consumer to communicate online and trade offline; the dealer imports product information from the manufacturer operating space through the cloud data server of the system, and then fills in a dealer product inventory, prices and transaction terms, so as to publish and sell products online.

9. The system, as recited in claim 8, wherein after trading between the dealer and the customer, the dealer product inventory changes accordingly, and the dealer sends a purchase order to the manufacturer according to the dealer product inventory.

10. The system, as recited in claim 9, wherein the manufacturer's side receives an order sent by the dealer's side and generates a production plan based on a manufacture product inventory until shipment is completed.

11. The system, as recited in claim 6, wherein the consumer end enables the consumer to select a desired product online, and to send a purchase inquiry to the dealer or directly settle the purchase online.

12. The system, as recited in claim 11, wherein the dealer's end receives the purchase inquiry or an order from the consumer through the cloud data server of the system, which enables the dealer and the consumer to communicate online and trade offline; the dealer imports product information from the manufacturer operating space through the cloud data server of the system, and then fills in a dealer product inventory, prices and transaction terms, so as to publish and sell products online.

13. The system, as recited in claim 12, wherein after trading between the dealer and the customer, the dealer product inventory changes accordingly, and the dealer sends a purchase order to the manufacturer according to the dealer product inventory.

14. The system, as recited in claim 13, wherein the manufacturer's side receives an order sent by the dealer's side and generates a production plan based on a. manufacture product inventory until shipment is completed.

15. A method for manufacturer, dealer and consumer joint transaction, comprising steps of:
selecting registered dealers from various places by a manufacturer on a system, or allowing approved a dealer to settle on a platform, thereby confirming a cooperation relationship between the manufacture and the dealer, as well as a sale scope;
after the dealer application is approved, conducting online and/or offline operations by the dealer within the sale scope designated by the manufacturer; and
searching for a desired product by a registered consumer within a certain area nearby through a dealer cloud data server, and settling purchase with the dealer online.

16. The system, as recited in claim 15, wherein the sale scope comprises products to be sold, sale areas and quantities; and data association is performed between the manufacture, the dealer and the customer within the sale scope.

17. The system, as recited in claim 16, wherein the manufacturer edits and uploads product or service information but not sell online; the dealer does not edit and upload the product or service information, but only imports the product or service information from a product database of the manufacturer or a superior dealer to whom a cooperative relationship is established; dealer product data are automatically updated when manufacturer product data are updated.

18. The system, as recited in claim 17, wherein the consumer sends a purchase inquiry to the dealer or directly settle the purchase online.

19. The system, as recited in claim 18, wherein after receiving the purchase inquiry, negotiating is performed between the consumer and the dealer online until an order is confirmed or cancelled.

20. The system, as recited in claim 19, wherein after receiving a confirmed order from the consumer, the dealer issues a shipment order and shipping the product to the consumer if a dealer product inventory is sufficient, or generates and sends a purchase order to the manufacturer if the dealer product inventory is insufficient.

21. The system, as recited in claim 20, wherein after confirming the purchase order sent by the dealer, the manufacturer compares product inventory data for generating a production plan according to a manufacture product inventory, which comprises steps of:
when the manufacture product inventory is insufficient or reaches an inventory warning line, generating and sending the production plan to a production department; after the production department completes order production, importing new product data information into a product database, wherein the system automatically sends product warehousing and saleable information to the sales department; and
when the manufacture product inventory is sufficient, confirming the purchase order by a sales department of the manufacturer, and issuing a shipment order and shipping the product to the dealer; after the sales department of the manufacturer issues the shipment order and ships the product to the dealer, automatically updating original product information in the product database.

22. The system, as recited in claim 21, wherein after the dealer receives and confirms the shipping order from the manufacturer, the new product data information is automatically updated to the dealer product inventory.)

23. The system, as recited in claim 22, wherein the dealer sends shipping order information to the consumer, and updates the dealer product inventory accordingly.
